(19) United States
(12) Patent Application Publication
(10) Pub. No.: US 2026/0330722 A1
(43) Pub. Date: Oct. 22, 2026

(54) IMAGE FILTERING APPARATUS

(71) Applicant: SafeLens Technologies LLC, St. Petersburg, FL (US)

(72) Inventor: Quincey SULLIVAN, St. Petersburg, FL (US)

(73) Assignee: SafeLens Technologies LLC, St. Petersburg, FL (US)

(21) Appl. No.: 19/237,085

(22) Filed: Jun. 13, 2025

Related U.S. Application Data
(60) Provisional application No. 63/791,469, filed on Apr. 19, 2025.

(51) Int. Cl. G06T 11/60; G06T 1/60; G06V 40/16; G06V 40/20

(52) U.S. Cl. CPC G06T 11/60; G06T 1/60; G06V 40/174; G06V 40/20

(57) ABSTRACT

There is described an apparatus for filtering images, the apparatus comprising: a processor; and a memory component having instructions stored thereon that, when executed by the processor, cause the processor to perform operations comprising: receiving an image signal from an image sensor of a computer device, the image signal comprising an image captured by the image sensor; processing the image signal so as to determine whether content of a first type is present within the image; and based on content of the first type not being present within the image, transmitting the image signal to an image signal processor of the computer device; or based on content of the first type being present within the image: blocking the image signal from being sent to the image signal processor; and/or modifying the image signal before transmitting the image signal to the image signal processor.

### RELATED APPLICATION(S)

This application claims the benefit of priority under 35 USC § 119(e) of U.S. Provisional Patent Application No. 63/791,469 filed on Apr. 19, 2025, the contents of which are incorporated by reference as if fully set forth herein in their entirety.

### FIELD AND BACKGROUND OF THE INVENTION

The present invention relates to methods, apparatuses, and systems for image filtering. In particular, the present invention relates to an apparatus that can be combined with an image sensor in order to prevent operation of that image sensor so as to prevent the capturing of certain images.

The proliferation of smartphones among minors has led to a dramatic rise in the self-generation of inappropriate imagery. Software-based parental control tools are often ineffective due to their reliance on app-level permissions, easy bypassing by tech-savvy minors, and their reactive rather than preventive nature.

Existing solutions also tend to operate after an image has already been captured or shared, rendering them insufficient for truly preventative content safety.

Therefore, improved methods of image filtering are desired.

### SUMMARY OF THE INVENTION

According to an aspect of the present disclosure, there is described: an apparatus for filtering images, the apparatus comprising: a processor; and a memory component having instructions stored thereon that, when executed by the processor, cause the processor to perform operations comprising: receiving an image signal from an image sensor of a computer device, the image signal comprising an image captured by the image sensor; processing the image signal to determine whether content of a first type is present within the image; and (e.g. either:) based on content of the first type not being present within the image, transmitting the image signal to an image signal processor of the computer device; or based on content of the first type being present within the image: blocking (or preventing or disabling) the image signal from being sent to the image signal processor or modifying the image signal before transmitting the image signal to the image signal processor.

According to an aspect of the present disclosure, there is described: an apparatus for filtering images, the apparatus comprising: means for (e.g. a communication interface and/or a processor for): receiving an image signal from an image sensor of a computer device, the image signal comprising an image captured by the image sensor; means for (e.g. a processor for) processing the image signal to determine whether content of a first type is present within the image; and means for (e.g. a processor and/or a communication interface for) based on content of the first type not being present within the image, transmitting the image signal to an image signal processor of the computer device; or based on content of the first type being present within the image: blocking (or preventing or disabling) the image signal from being sent to the image signal processor or modifying the image signal before transmitting the image signal to the image signal processor.

According to an aspect of the present disclosure, there is described: an apparatus for filtering images, the apparatus comprising a processor arranged to perform operations comprising: receiving an image signal from an image sensor of a computer device, the image signal comprising an image captured by the image sensor; processing the image signal to determine whether content of a first type is present within the image; and (e.g. either:) based on content of the first type not being present within the image, transmitting the image signal to an image signal processor of the computer device; or based on content of the first type being present within the image: blocking (or preventing or disabling) the image signal from being sent to the image signal processor or modifying the image signal before transmitting the image signal to the image signal processor.

Preferably, the operations comprise, based on content of the first type being present within the image: modifying the image signal before transmitting the image signal to the image signal processor.

Preferably, the operations comprise, based on content of the first type being present within the image: modifying the image signal before transmitting the image signal to the image signal processor.

Preferably, the apparatus is arranged to provide a hardware interrupt, whereby the apparatus provides a hardware apparatus so as to prevent software-level bypassing of the apparatus.

Preferably, the image is a frame of a video and/or the image signal comprises one or more frames of a video.

Preferably, the operations comprise disabling the image sensor based on content of the first type being present in the image.

Preferably, the apparatus is an apparatus for filtering frames of a video, where the apparatus is arranged to process one or more (e.g. a plurality of) frames of the video to determine whether content of the first type is present in the video.

Preferably, the memory component comprises a volatile memory component for temporarily storing the image. Preferably, the volatile memory comprises a static random access memory (SRAM) and/or wherein the image is arranged to be stored only in the volatile memory.

Preferably, the filter is arranged to stop the provision of power to the volatile memory component, preferably wherein the filter is arranged to stop the provision of power to the volatile memory component following the processing of the image signal.

Preferably, the filter is arranged to stop the provision of power when a deactivation condition is satisfied. Preferably, the deactivation condition comprises one or more of: a user closing a camera application; a user stopping use of the image sensor; and a user locking the computer device.

Preferably, the filter is arranged to filter a plurality of images and to repeatedly determine whether an operating condition is met while filtering the images. Preferably, the filter is arranged to stop the provision of power to the volatile memory condition if the operating condition is not met.

Preferably, the filter is arranged not to provide power to the volatile memory in a default state. Preferably, in the default state the filter is receiving power but is not providing power to the volatile memory. Preferably, the filter is in the default state if an operating condition is not met.

Preferably, the memory component comprises an enclave for storing data permanently.

Preferably, the enclave stores parameters and/or weights of a machine learning model, wherein determining whether content of the first type is present comprises determining whether content of the first type is present using the machine learning model.

Preferably, the machine learning model comprises a convolutional neural network (CNN), preferably a lightweight CNN optimized for on-chip processing.

Preferably, the enclave comprises an encrypted secure enclave storing tamper resistant firmware and model weights.

Preferably, the apparatus is apparatus for filtering video. Preferably, the operations comprise: receiving one or more image signals from an image sensor of a computer device, the image signals comprising a plurality of images captured by the image sensor, the plurality of images being associated with a video; and processing the image signal to determine whether content of a first type is present within the video.

Preferably, the operations comprise: based on content of the first type not being present within the image, transmitting the image signals to an image signal processor of the computer device.

Preferably, the operations comprise: based on content of the first type being present within the image: blocking one or more of the image signals from being sent to the image signal processor or modifying one or more of the image signals before transmitting the image signal to the image signal processor.

Preferably, the operations comprise: receiving one or more image signals from an image sensor of a computer device, the image signals comprising a plurality of images captured by the image sensor, the plurality of images being associated with a video; processing the image signals to determine whether content of a first type is present within the plurality of images; and based on content of the first type not being present within the plurality of images, transmitting the image signals to an image signal processor of the computer device; or based on content of the first type being present within the plurality of images: blocking one or more of the image signals from being sent to the image signal processor or modifying one or more of the image signals before transmitting the image signal to the image signal processor.

Preferably, the first type of content comprises one or more of: nudity, suggestive poses, and contextual indicators of private settings.

Preferably, the operations comprise modifying and/or deleting previously taken images based on content of the first type being present.

Preferably, the operations comprise clearing a memory and/or a cache of the apparatus following the determination of whether content of the first type is present so as to delete the image from the apparatus. Preferably, the image is stored only in a cache of the apparatus.

Preferably, the operations comprise clearing a memory and/or a cache of the computer device following the determination of whether content of the first type is present so as to delete the image from the computer device.

Preferably, the operations comprise blocking a shutter of the image sensor based on content of the first type being present.

Preferably, the operations comprise one or more of: disabling a shutter trigger, altering a frame buffer of the image sensor and/or the computer device, preventing storage of the image (e.g. in a memory of the computer device); preventing transmission of the image (e.g. by a communication interface of the computer device) and/or replacing pixels of the image in real time based on content of the first type being present.

Preferably, the operations comprise, based on content of the first type being present, blocking the image signal from being sent to a memory of the computer device.

Preferably, the operations comprise: blocking the image signal from being sent to the image signal processor or modifying the image signal before transmitting the image signal to the image signal processor and/or before enabling any storage or transmission of the image by the computer device.

Preferably, the apparatus is arranged to prevent the capture of images using the image sensor based on a fault in the apparatus being detected.

Preferably, the apparatus is arranged to block the transmission of the image signal to the image signal processor when the apparatus is in a default state and/or an off state.

Preferably, the apparatus comprises a tamper-detection device, wherein the apparatus is arranged to block the transmission of the image signal to the image signal processor based on an activation of the tamper-detection device.

Preferably, following a detection of tampering, the apparatus is arranged to operate in a blocking mode until the blocking mode is removed by an administrator.

Preferably, the operations comprise modifying one or more image pixels associated with the first type of content.

Preferably, the operations comprise blocking the image from being shown on a display of the computer device based on content of the first type being present.

Preferably, the operations comprise: enabling the image to be saved and/or sent by the image signal processor based on content of the first type not being present in the image.

Preferably, the operations comprise: identifying an operating condition of the apparatus; determining that the operating condition is satisfied; and processing the image based on the operating condition being satisfied.

Preferably, determining that the operating condition is satisfied comprises one or more of: detecting an activation of the image sensor; detecting an activation of an application; determining that a contextual condition is satisfied, preferably determining that a time or location condition is satisfied; determining that an image detection is satisfied; determining that a proximity condition is satisfied, preferably determining that the computer device is within a threshold distance of a further computer device; determining that an audio input condition is satisfied; and detecting a gesture in the image.

Preferably, determining the operating condition is satisfied comprises one or more of: determining that a user is attempting to take a screenshot on the computer device; determining that a user is attempting to initiate screen recording on the computer device; and determining that a user is attempting to use a camera on the computer device.

Preferably, determining that the operating condition is satisfied comprises determining that the image has been captured during an administrator-defined time window.

Preferably, the operations comprise disabling the image sensor and/or processing images to determine whether the first type of content is present based on a contextual condition being met. Preferably, the operations comprise disabling the image sensor and/or processing images to determine whether the first type of content is present based on the computer device being within a geofence.

Preferably, the operations comprise processing the image in dependence on a filtering parameter.

Preferably, the filtering parameter is dependent on one or more of: an administrator setting, preferably a detection sensitivity parameter set by an administrator; a time and/or location at the time of the image being captured; an expression detected in the image; a gesture detected in the image; a characteristic of a user of the computer device, preferably an age of the user; and an audio input detected by a microphone of the apparatus and/or the user device.

Preferably, the operations comprise sending a report to an administrator. Preferably, the operations comprise sending the report in dependence on content of the first type being present.

Preferably, the report comprises one or more of: a description of the image and/or an indication of a type of content in the image; and contextual data relating to the capture of the image, e.g. a time or location of the capture of the image.

Preferably, the report does not comprise the image.

Preferably, the operations comprise: sending the report using a communication interface of the computer device.

Preferably, the operations comprise: performing a first stage of filtering and a second stage of filtering, wherein the second stage of filtering is more detailed than and/or requires more time than the first stage of filtering.

Preferably, the apparatus is arranged to perform the first stage of filtering on an image signal before forwarding said image signal to the image signal processor and to perform the second stage of filtering on the same image signal after forwarding said image signal to the image signal processor.

Preferably, the apparatus is arranged to alter a filtering parameter for implementing the first stage of filtering on a first, e.g. later, image in dependence on the processing of a second, e.g. earlier, image during the second stage of filtering.

Preferably, processing the image comprises processing the image based on a camera setting of the image sensor, preferably based on a camera setting indicated by the image signal (e.g. a shutter speed, a color balance, an exposure time etc.).

Preferably, the apparatus comprises a (e.g. filtering) computer device, preferably a microchip.

Preferably, the apparatus comprises a standalone image-filtering co-processor integrated into a mobile device.

Preferably, the apparatus comprises an embedded module in a camera pipeline.

Preferably, the apparatus is arranged to perform the processing on device without any network connection.

Preferably, the apparatus comprises a dedicated filtering device (e.g. where the apparatus is configured for the sole purpose of filtering image signals).

Preferably, the apparatus comprises, or provides, a system-in-package or an IP-block arrangement.

Preferably, the apparatus is separate from, and preferably segregated and/or air-gapped from, the image sensor and the image signal processor.

Preferably, the processing of the image signal occurs entirely on the apparatus and/or wherein the processing of the image signal occurs offline.

Preferably, the processing of the image signal occurs prior to the image signal being transmitted to the image signal processor.

Preferably, the apparatus comprises a communication interface, preferably a communication interface that is separate to a device communication interface of the computer device.

Preferably, the computer device comprises a smartphone.

According to another aspect of the present disclosure, there is described a computer device comprising: the aforesaid apparatus; the image sensor; and the image signal processor.

Preferably, the apparatus comprises a smartphone.

Preferably, the image sensor is arranged to transmit signals to the image signal processor via the apparatus. Preferably, all signals from the image sensor to the image signal processor are arranged to be transmitted via the apparatus.

Preferably, the image sensor is also arranged to transmit signals to the image signal processor directly.

Preferably, the image sensor is arranged to transmit image signals to the apparatus based on an operating condition of the apparatus being satisfied.

Preferably, the image sensor is arranged to transmit image signals to the image signal processor based on an operating condition of the apparatus not being satisfied.

Preferably, the computer device comprising a power supply, wherein the computer device is arranged to control a supply of power to the apparatus and/or to a volatile memory of the apparatus, preferably wherein the device is arranged to control the supply of power based on instructions from the processor of the apparatus.

Preferably, the computer device is arranged to stop a supply of power to the apparatus and/or to a volatile memory of the apparatus based on a deactivation condition of the apparatus being satisfied and/or based on an operating condition of the apparatus not being satisfied.

Preferably, the apparatus is retrofitted in the computer device.

According to another aspect of the present disclosure, there is described a method comprising: receiving an image signal from an image sensor of a computer device, the image signal comprising an image captured by the image sensor; processing the image signal to determine whether content of a first type is present within the image; and based on content of the first type not being present within the image, transmitting the image signal to an image signal processor of the computer device; or based on content of the first type being present within the image: blocking the image signal from being sent to the image signal processor or modifying the image signal before transmitting the image signal to the image signal processor.

According to another aspect of the present disclosure, there is described a method of retrofitting the aforesaid apparatus to a computer device.

According to another aspect of the present disclosure, there is described a hardware-based content filtering system for preventing the capture of inappropriate imagery, comprising: a camera sensor configured to stream live image frames; a dedicated microchip positioned between the camera sensor and an image signal processor, the microchip including: volatile memory for temporary frame caching; a convolutional neural network (CNN) inference engine trained to detect inappropriate content; and logic circuitry for evaluating said frames in real time; and a blocking mechanism configured to prevent image capture or storage if inappropriate content is detected, wherein all processing occurs on-device and prior to any frame being stored, transmitted, or accessed by the operating system.

Preferably, the system further comprises a time-based control module configured to block camera access during administrator-defined time windows.

Preferably, the microchip includes an encrypted secure enclave storing tamper-resistant firmware and model weights.

Preferably, the blocking mechanism disables a shutter trigger or alters flagged frame pixels in real time using irreversible transformation.

Preferably, the CNN inference engine is trained to detect nudity, suggestive poses, or contextual indicators of private settings.

Preferably, the system further comprises a time-based control module configured to block camera access during administrator-defined time windows.

Preferably, the system further comprises a geofencing module that disables the camera in defined physical locations using GPS or network data.

Preferably, all frame analysis is completed within a predefined latency threshold of 100 milliseconds or less.

Preferably, the system further comprises gesture recognition logic configured to detect behavioral cues or intent preceding inappropriate imagery.

Preferably, failure of the microchip to initialize results in a default locked state preventing image capture.

Preferably, all processing and analysis is performed offline and without the need for wireless or cloud connectivity.

Aspects of the present disclosure relate to a system architecture that includes a dedicated co-processor (like an Image Safety Module or ISM) that interfaces directly with an image sensor pipeline before any image reaches memory or storage.

The architecture may keep a ‘SafeLens’ filtering apparatus isolated from user-level apps and cloud access, similar to a Secure Enclave, but focused on image content filtering.

The architecture may optimize for parallel processing of video frames with minimal latency.

The architecture may add a dedicated inference engine (e.g., compact CNN accelerator) embedded within the image processing pipeline—e.g. between a sensor and a camera app, or directly within an image signal processor.

The architecture may use hardware interrupts that trigger the SafeLens filter as soon as a camera API is accessed.

The architecture may ensure modular integration so the chip can be added to existing SoCs or act as a companion chip.

Aspects of the present disclosure relate to a detection method that provides a lightweight convolutional neural network (CNN) trained specifically to detect nudity, private body parts, or adult poses in live image data.

The detection method may include filters that detect proximity, skin tone ratios, and anatomical cues in multiple body positions, even in low-light or partial frames.

The detection method may use pose detection and segmentation to enhance precision and reduce false positives.

The detection method may use low-latency CNN or ViT (Vision Transformer) models, trained specifically to detect skin exposure, body outlines, and contextual cues (bed, mirror, etc.).

The detection method may prioritize bounding-box analysis on edge regions of the frame for speed.

The detection method may include a motion detector to identify posing or suggestive gestures to increase accuracy.

The present disclosure describes a triggering method that may trigger on camera app activation or pre-capture frame preview, allowing the SafeLens filtering apparatus to scan frames before shutter activation.

The triggering method may tie into screen mirroring, screenshot attempts, and third-party app cameras.

The triggering method may give parents/admins control over sensitivity thresholds and monitoring windows (e.g., “Block camera between 10 p.m.-6 a.m.”).

The triggering method may trigger automatically whenever the camera preview stream begins, including third-party apps and even video modes.

The triggering method may provide manual override toggles in settings (e.g., “Safe Mode ON”).

The triggering method add a privacy status LED to indicate the SafeLens filtering apparatus is filtering content.

Aspects of the present disclosure relate to a blocking mechanism whereby, if the SafeLens filtering apparatus detects an inappropriate object, the apparatus refuses to allow image capture, or instantly scrubs pixels before committing to memory.

The blocking mechanism may enable an apparatus to blur, pixelate, or substitute blocked areas in real time with irreversible transformations.

The blocking mechanism may add a user/parent notification option when blocked events occur.

The blocking mechanism may insert the SafeLens filtering apparatus directly into the optical pipeline, where it either: blurs defined regions before the user can take a photo, or locks shutter function if content crosses a sensitivity threshold.

The blocking mechanism may ensure no software bypass is possible, e.g. unless physically toggled via parent/admin controls.

Aspects of the present disclosure relate to a hardware that may be camera-agnostic, operating directly off of framebuffer or ISP output with minimal drain.

The hardware may integrate a thermal or near-infrared overlay sensor for better detection under clothing or in low light.

The hardware may target a <100 ms detection and response time.

The hardware may prioritize a low-power neural inference accelerator, like Google's Edge TPU or a custom ASIC that supports TensorFlow Lite models.

The hardware may fit into existing camera modules or as an inline chip on the imaging circuit.

The hardware may include an on-chip cache for model weights and privacy rules.

Aspects of the present disclosure relate to an apparatus that provides security and privacy in which all analysis is performed on-device, in a non-recoverable and ephemeral manner.

This may involve parents or admins only seeing a log of blocked actions, not actual flagged images.

This may involve the apparatus not requiring an internet connection should be needed—the apparatus may focus on air-gapped protections.

This may involve the apparatus never storing images—and instead only analyzing images in memory before discarding the images.

This may involve the apparatus encrypting chip firmware and detection model at rest.

This may involve the apparatus using tamper-proof hardware to prevent rooting or firmware modification.

This may involve the apparatus allowing parental/local authority management, but not cloud control.

Aspects of the present disclosure relate to an apparatus that may be designed for modular integration with existing platforms, e.g. Android-based platforms.

The apparatus may comprise a physical chip that can be to handset makers.

The apparatus may be future-proof with potential for wearables, tablets, and smart displays.

The apparatus may be provided as an OS-agnostic plug-in that can work with Android/iOS or embedded systems.

The apparatus may provide SDKs and API hooks for camera developers to detect the SafeLens filtering apparatus.

The present disclosure describes an image filtering apparatus that may comprise a dedicated microchip arranged to detect and block inappropriate camera content in real time. This apparatus may function independently of internet access or cloud services and may not store any image data permanently. In particular, the apparatus may use an on-chip volatile memory (e.g., SRAM or cache) and/or a trained convolutional neural network (CNN) inference engine to analyze live video frames at the hardware level. When content deemed inappropriate is detected, the apparatus may block the shutter trigger, preventing the image from being captured or saved. This detection and blocking may occur prior to any image write or memory commit. The apparatus may also support configurable thresholds and parental override settings that may be integrated securely in an administrative dashboard or via onboard firmware settings.

The apparatus may comprise a real-time, chip-level content filtering architecture embedded within the camera processing pipeline of smartphones or similar imaging-enabled devices. The apparatus may be designed to intercept and analyze live video frames prior to capture, providing a hardware-based solution to prevent the generation of inappropriate imagery.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the disclosure can be implemented and/or supplied and/or used independently.

The disclosure extends to methods and/or apparatus substantially as herein described with reference to the accompanying drawings.

### BRIEF DESCRIPTION OF THE SEVERAL VIEWS OF THE DRAWING(S)

The disclosure will now be described, by way of example, with reference to the accompanying drawings.

FIGS. 1a and 1b show computer devices that comprises an image filtering apparatus.

FIGS. 2 and 3 show modules of exemplary computer devices.

FIGS. 4 and 5 show methods of operating an image filtering apparatus.

FIG. 6 shows an exemplary interface for controlling the operation of an image filtering apparatus.

### DESCRIPTION OF SPECIFIC EMBODIMENTS OF THE INVENTION

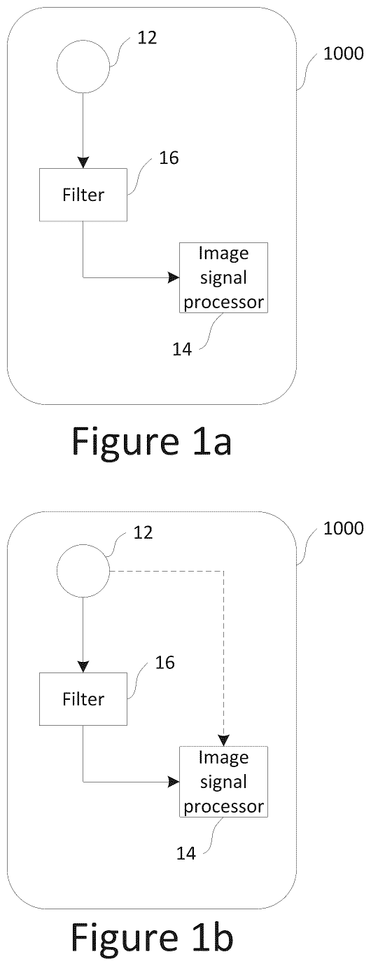

Referring to FIGS. 1a and 1b, there is shown a computer device 1000 that comprises an image sensor 12 (e.g. a camera) and an image signal processor 14. The image sensor is arranged to capture an image (e.g. a standalone image and/or a frame of a video) and to transmit this image to the image signal processor. The image signal processor is arranged to process and/or store the image, e.g. to present the image to the user or to store the image in a memory of the computer device.

In some embodiments, the image signal processor 14 comprises a dedicated component of the computer device 1000. In other embodiments, the image signal processor may be a part of another processor of a computer device. For example, images captured by a camera of a smartphone may be processed by a CPU or GPU of that smartphone (where this CPU/GPU could then be considered to be an ‘image signal processor’).

To operate the computer device, a user may position a camera (e.g. a rear camera or a front camera of a smartphone), view a feed from the camera, and then operate the smartphone to save the image (e.g. to save the image in a memory of the computer device).

Problematically, this may result in inappropriate content being captured or saved. For example, an underage user may use the device to save and share nude images.

To prevent such usage of the device, the present disclosure provides an image filtering apparatus 16 (hereafter referred to as the ‘filter’ or as a ‘SafeLens’ device) that is used to process images captured by the image sensor before these images are processed by the image signal processor 14 (or in some embodiments, while these images are processed by the image signal processor).

The filter 16 is arranged to detect inappropriate content within an image and to prevent the capturing or saving of the image by the image signal processor.

Referring to FIG. 1a, typically the filter 16 is arranged to intercept all signals between the image sensor 12 and the image signal processor 14. Therefore, the filter may prevent images from even being shown on the computer device.

Equally, referring to FIG. 1b, in some embodiments the image sensor 12 is arranged to communicate with the image signal processor 14 both directly and also via the filter 16. Therefore, the image signal processor may be arranged to display images in real time (e.g. to enable a user to view a camera feed), while the filter prevents the saving or sharing of the images.

Alternatively, or additionally, with this embodiment of FIG. 1b, the filter 16 may be activated based on an operating condition being satisfied (so that signals are sent from the image sensor 12 to the image signal processor 14 via the filter 16 when this operating condition is satisfied), whereas otherwise signals are sent from the image sensor directly to the image signal processor.

The filter 16 is implemented as a hardware apparatus, e.g. a microchip, where this prevents a user bypassing the filter by altering software of the computer device. In particular, the filter may be provided within the computer device 1000 separately to another processor of the computer device, e.g. the image signal processor 14. This enables the other processor of the computer device to perform conventional operations, and the filter to be provided as an additional component (e.g. that can be included in a conventional device architecture) that can prevent images from even being received by the other processor. In such embodiments, the operation of the other processor is not affected by the filter, instead the filter affects the signals reaching the other processor. Therefore, the filter can be provided alongside a conventional processor without needing a user to alter the operation of the conventional processor and without enabling this conventional processor to override the operations of the filter.

In this regard, providing the filter 16 in the form of a hardware apparatus prevents, for example, a user from a smartphone from overriding the filtering operations provided by the filter. Even if a user is able to access administrator privileges of the other processor of the computer device 1000, they still will not be able to view or store inappropriate content since this content is not even received by the other processor.

In some embodiments, the computer device 1000 comprises a smartphone. In other embodiments, the computer device may comprise one or more of: a personal computer, PC, a wearable device, such as a smartwatch, a camera, such as a digital camera, etc.

Typically, the filter 16 is arranged to be compatible with Android, iOS, and other embedded imaging platforms as well as being adaptable to other camera-enabled hardware such as wearables, tablets, and educational devices.

The filter 16 may be provided as a physical chip or as an embeddable block for system-on-chip integration. Software developer kit (SDK) and application programming interface (API) hooks may be provided to allow developers and original equipment manufacturers (OEMs) to recognize and interact with functions of the filter. In some embodiments, the filter and the image signalling processor are provided on a shared chip (albeit typically with different processors and/or software).

The filter 16 may be provided as a modular addition to the computer device and may be embedded in a system-on-chip component of the computer device or as an inline component.

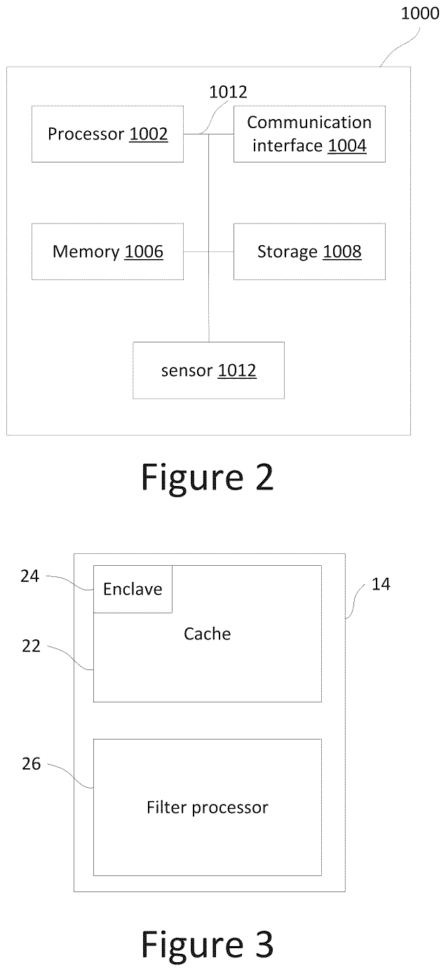

Referring to FIG. 2, the computer device 1000 typically comprises one or more of:
A processor 1002 for executing instructions (e.g. so as to perform one or more of the steps of the various methods described below).
A communication interface 1004 for facilitating communication between computer devices (e.g. an ethernet interface, a Bluetooth® interface, or a universal serial bus (UBS) interface).
A memory 1006 and/or storage 1008 for storing information and instructions (e.g. a random access memory (RAM), a read only memory (ROM), a hard drive disk (HDD) a solid state drive (SSD), and/or a flash memory.
A sensor 1012, such as the image sensor 12, Typically, the computer device comprises a camera that is arranged to capture live image frames.
A user interface (e.g. a display, a mouse, a keyboard, and/or an emergency stop button) for enabling a user to interact with the computer device.
These components may be coupled to one another by a bus 1012 of the computer device.

Typically, the filter 16 comprises an apparatus that is arranged to be installed into/onto a computer device. The filter may also be implemented as a computer device in its own right. In particular, the filter may comprise a processor and may comprise a memory.

In this regard, referring to FIG. 3, the filter 16 typically comprises a cache 22 that is in the form of volatile memory, whereby an interruption to the power supply of the volatile memory causes a loss of the data in the cache. Therefore, each time the filter 16 is deactivated (e.g. when the computer device is turned off), the cache is cleared. Typically, the filter is arranged to clear the cache regularly (e.g. after each image is processed by the filter, or after inappropriate content is identified) in order to ensure that any inappropriate messages are not saved. In various embodiments, the memory may comprise random access memory (RAM) and/or static random access memory (SRAM). Typically, the filter is configured to be capable of storing images in volatile memory only (e.g. so that the filter is unable to store images in long term, or non-volatile memory).

The filter 16 may also contain an enclave memory component 24 that is arranged to store long-term data. For example, the enclave may store data that enables the filter to analyse images for inappropriate content. In particular, the filter may analyse images using a machine learning model or a neural network and the enclave may store parameters or weights of this machine learning model. For example, the enclave may comprise read only memory (ROM). The enclave may also store an operating system, BIOS, or operating instructions for the filter (e.g. to enable the filter to receive and process images according to these instructions).

The filter 16 comprises a filter processor 26 that is arranged to analyse images received from the image sensor. The filter processor typically comprises an inference engine, such as a convolutional neural network (CNN) that is arranged to identify inappropriate content within an image. The processor is typically arranged to either allow the image to pass through to the image signal processor 14 of the computer device 1000 or to block the passage of the image. In some embodiments, the filter processor may modify the image before passing it to the image signal processor; for example, the filter processor may apply a blurring effect to inappropriate parts of the image (e.g. to exposed genitalia) before passing the image through to the image signal processor. The analysis typically occurs entirely on-chip (on the filter) so that there is no risk of inappropriate images leaking from the filter.

Typically, the filter 16 receives an image signal comprising an image from the image sensor 12. Where the image is found to be allowable (e.g. to not contain inappropriate content), the filter may forward the image signal to the image signal processor 14 without modifying the signal. Where the image is found to contain inappropriate content, the image signal may be blocked or modified (e.g. to modify the image or to flag to the image signal processor that the image might contain inappropriate content).

The filter processor may support TensorFlow Lite and/or low-power acceleration. The enclave 24 may be arranged to store model weights in read-only memory within a tamper-resistant secure enclave. Typically, the cache 22 is arranged and operated so that no image data is saved beyond the duration of analysis.

Typically, the cache 22 is arranged to encrypt incoming image signals so that all analysis is performed in encrypted memory. Typically, the enclave 24 is arranged so that the firmware of the filter 15 is non-modifiable and/or non-modifiable without hardware-level override.

In some embodiments, the filter 16 is arranged to provide logging features or reports. For example, the filter may provide timestamped activity alerts (e.g., “Image blocked at 9:12 PM”), viewable only by verified administrators.

In some embodiments, the filter 16 comprises a communication interface and/or the filter is arranged to interact with a communication interface of the computer device 1000. The filter may use this communication interface to send information, such as logging reports, to an administrator or a third party. For example, where the computer device is a smartphone owned by a child, the filter may be arranged to send (or to cause the sending of) reports whenever inappropriate activity is determined.

Typically, the filter 16 is arranged to use the communication interface of the computer device to send these reports, where the reports are typically textual and/or descriptive so that the reports describe an operation but do not transfer any inappropriate images off the filter. In some embodiments, the filter processor 26 is arranged to provide an indication of an image, e.g. to identify why an image is deemed to be inappropriate; for example, the filter processor may be arranged to indicate whether an image contains nudity or a suggestive pose. Equally, the filter processor may block an image without providing a reason. The reports may then indicate that an image has been blocked and/or may indicate a reason for the blocking. Furthermore, the reports may indicate a context, e.g. a time or location, of the blocking. By using the communication interface of the computer device instead of an in-built communication interface, a lower cost filter can be provided. Equally, by providing a filter with an in-built user interface, further control can be provided to the filter (e.g. to prevent a user from blocking the reports by disabling the communication interface of the computer device).

The filter 16 may be arranged to provide a report or a notification based on a reason for blocking an image or a context (e.g. a time) at which an image has been blocked. For example, a recipient of a report may be determined based on this reason or context, where some reports may be sent to a user's parent and some may be sent to a third party (e.g. a safeguarding professional). Similarly, a level of detail of a report may be based on this reason or context, e.g. so that images with a suggestive pose are blocked without a report being sent but images that contain sexual activity lead to a report being sent.

Typically, the filter 16 is arranged to operate offline (i.e. without any network connectivity). Typically, the filter is arranged to operate in an air-gapped manner, where the determination of inappropriate content is determined using only algorithms and logic on the filter (albeit receiving an image as an input).

Typically, the filter 16 is arranged to perform an image processing operation in a short time, e.g. with a latency threshold of 100 milliseconds or less, where this enables an image to be filtered while still being presented to a user in near-real time (so that the user can still, for example, participate in live video calls and can still view an (almost) live video feed.

In some embodiments, the filter 16 is arranged to perform a two-stage filtering process. For example, the filter may perform a first stage of a filtering process in order to determine whether an image can be forwarded to the image signal processor 14 and may then perform a second stage of a filtering process to determine whether the image can be saved or shared.

In practical applications, this may involve the filter 16 using the first stage process to detect evident signs of inappropriate content (e.g. nudity) and then using the second stage process to detect more subtle signs of inappropriate content (e.g. gestures). The first stage may be performed before the image is forwarded to the image signal processor 14 with the second stage being performed while the image is being processed by the image signal processor (and/or displayed to a user). The second stage may complete prior to a user attempting to save and/or share the content, so that with this method certain inappropriate content may be viewed by a user but this inappropriate content still cannot be saved or shared.

Similarly, the second stage may be used to detect subtle predictors that inappropriate content is likely to occur in the near future. This may be used to predictively block the image sensor from capturing images. In some embodiments, the results of the second stage are used to change a filtering parameter (e.g. a sensitivity) of the first stage. Therefore, the filter may determine based on a, e.g. lengthy second stage, analysis of a video frame that a future frame is likely to contain inappropriate content and the filter may lower a sensitivity threshold for a (e.g. first stage) analysis of this future frame based on this determination. This method reduces the change of inadvertently blocking appropriate images (as could occur with a fixed high sensitivity) while maintaining a low chance of letting through inappropriate images (as could occur with a fixed low sensitivity).

Furthermore, such an implementation ensures that a user does not notice a significant delay between capturing and viewing images while still enabling detailed processing to occur (however, this can increase the risk of inappropriate content leaking from the filter 16 since images may be passed through to the image signal processor 14 before processing is complete). As an example, the first stage of filtering may take 100 milliseconds and the second stage of filtering may take 500 milliseconds. The filter may be arranged to filter a plurality of images simultaneously, where a current image may be undergoing first stage processing while a previous image is undergoing second stage processing.

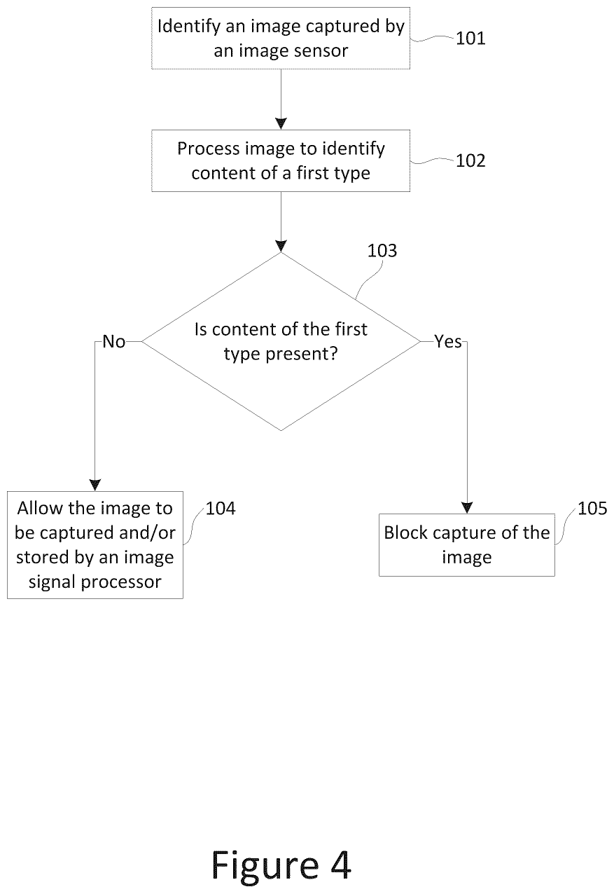

Referring to FIG. 4, there is described a method of filtering content that may be performed by the filter 16 (or another device that comprises a processor).

In a first step 101, the filter 16 identifies an image captured by an image sensor 12. Typically, this comprises the filter receiving an image from the image sensor and/or intercepting an image signal that is being transmitted from an image sensor to an image signal processor 14 (e.g. so that this image is provided to the image signal processor via the filter). This can be considered as the filter receiving an image signal from the image sensor, where the image signal contains the image. The image signal may comprise further image information, e.g. relating to camera settings, the context (e.g. time and date) at which the image was captured, location data, etc.

The camera settings may, for example, comprise a shutter speed, a color balance, an exposure time etc.

In a second step 102, the filter 16 processes the image in order to identify content of a first type in the image.

The content of the first type typically comprises inappropriate content. For example, identifying the content of the first type may comprise identifying one or more of: nudity, suggestive or offensive poses and/or gestures, a certain type of clothing, etc. In some embodiments, the content is content that is predictive of inappropriate content. For example, the filter 16 may identify a pose of a user that is not inappropriate but that is a predictor of inappropriate content.

While the detailed description primarily considers the filtering of inappropriate content such as nudity or offensive content, it will be appreciated that various types of content can be filtered using the methods disclosed herein.

In a third step 103, the filter 16 determines whether content of the first type is present in the image.

The processing of the image and the determination of content of the first type typically involves use of a machine learning model, such as a lightweight CNN or a vision transformer (ViT) model that is implemented by the filter.

More generally, an algorithm, a machine learning model, an artificial intelligence algorithm, or conditional logic may be used to identify the content of the first type. Typically, the filter processor 26 is trained to identify one or more of nudity, private anatomical features, and suggestive poses across diverse lighting conditions. This may comprise the use of one or more of: bounding-box segmentation, motion analysis, skin-tone ratios, and contextual cues (e.g., bed, bathroom tiles, mirrors) to evaluate frame content.

The filter processor 26 may be arranged to identify one or more priority regions and to process the image based on these regions. For example, the filter processor may perform a bounding-box analysis on edge regions of an image. This identification of priority regions can increase the speed of the analysis.

More generally, the first content may comprise any type of content. For example, the filter 16 may be arranged to detect and block (or blur) trademarked items within a captured image. This may be used by film cameras to avoid the capture of inappropriate, e.g. trademarked, items during a filming process.

If content of the first type is present in the image, then in a fourth step 104, the filter 16 allows the image to be capture and/or stored by an image signal processor. Typically, this comprises forwarding (e.g. sending) a signal representing the image to the image signal processor 14.

If content of the first type is not present in the image, then in a fifth step 105, the filter 16 blocks capture of the image. This typically comprises blocking the image so as to prevent a signal representing the image from being sent to the image signal processor and/or so as to not forward (e.g. not send) a signal representing the image to the image signal processor.

Blocking capture of the image may comprise disabling or blocking a shutter of the image sensor 12 and/or discarding or overwriting any memory (of the filter or of the computer device) that stores an image taken by the image sensor. In some embodiments, the filter may cause the deletion of previous images that were taken prior to the detection of inappropriate content (e.g. where a current frame of a video is found to contain inappropriate content, the filter 16 may cause the deletion of previous frames of the video and/or to block the capture of frames following the current frame).

Blocking capture of the image may comprise one or more of: disabling a shutter trigger, altering a framebuffer of the image sensor and/or the computer device, and/or replacing flagged pixels in real time, e.g. with irreversible blurring or distortion. Typically, any blocking or modification of the image occurs before an image reaches permanent storage, e.g. on a memory of the computer device.

Typically, the filter 16 includes hardware-level interrupt logic to prevent saving or previewing of images.

Typically, the filter 16 is arranged to intercept all signals from the image sensor 12 to the image signal processor 14, such that there is a hardware interrupt between the image sensor and the image signal processor and no signals are able to move from the image sensor to the image signal processor without the approval of the filter. Furthermore, this arrangement may be implemented such that any failure in the filter prevents the transmission of signals from the image sensor to the image signal processor.

Typically, the filter 16 is arranged to fail closed so that any tampering or faults in the filter lead to the image sensor 12 being locked (so that images cannot be captured). Unlocking the image sensor may require the provision of an administrator password.

In this regard, the filter 16 may be arranged to block the transmission of an (or any) image signal from the image sensor 12 to the image signal processor when the filter is in a default state and/or an off state. Therefore, if a user attempts to tamper with the filter, e.g. by disrupting a supply of power to the filter, the filter blocks use of the image sensor. This mode of operation may comprise the filter sharing a power supply with the image sensor and/or may comprise the image sensor being connected to the image signal processor 14 via the filter so that the image signal processor cannot transmit a signal to the image signal processor without this signal being forwarded by the filter.

The filter 16 may comprise a tamper-detection device, e.g. a seal or a dead-man's switch that is arranged to detect tampering or loss of power with the filter and to move the filter into a blocking mode in which the filter blocks the transmission of an (or any) image signal from the image sensor 12 to the image signal processor 14. The blocking mode may be maintained until an administrator of the filter removes the blocking mode. The blocking mode may be implemented in hardware, software, or a combination of hardware or software. For example, the tamper-detection device may detect a loss of power to the filter and this may result in the filter blocking signals from the image sensor. When power is returned, the filter may initially operate in the blocking mode until this blocking mode is removed by an administrator.

In some embodiments, instead of blocking capture of the image, the filter 16 may be arranged to modify the image (e.g. to blur certain portions of the image).

Typically, the method comprises clearing a cache 22 of the filter following the fourth step 104 or the fifth step 105. This prevents any long term storage of inappropriate content. In some embodiments, the method comprises clearing the cache only if content of the first type is detected in the image.

In some embodiments, the filter 16 is arranged to be enable, activated, and/or operated in response to an operating condition. The operating condition may be the operation of the image sensor and/or the capturing of an image by the image sensor. Therefore, the filter can effectively provide a hardware interrupt based on the operating condition being met.

For example, the operating condition may comprise a user opening a camera application on a smartphone, where this results in the activation of the filter 16 so that each image captured by the camera is provided to the image signal processor 14 via the filter. In such embodiments, the filter 16 may be inactive during normal operation of the computer device and/or may be deactivated based on a deactivation condition being met.

For example, when the user closes a smartphone application (e.g. a camera application) or when the user locks their phone, the filter 16 may be deactivated.

Typically, the filter 16 is arranged to filter all signals passing between the image sensor 12 and the image signal processor 14. In some embodiments, the filter may be arranged to be active only based on the operating condition being met (where images captured when the activation condition has not been met are passed from the image sensor to the image signal processor without being filtered by the filter). This may comprise images bypassing the filter or images being forwarded by the filter without being processed by the filter.

The operating condition may be used so that only certain applications trigger the filter, or certain contextual conditions (e.g. the computer device being within a certain geographic area, or the image sensor being operated at a certain time).

In some embodiments, the determination of the first type of content is based on the further information (e.g. the camera settings) indicated in the image signal. In particular, a sensitivity of the filtering or a focus of the filtering may be determined based on this information. For example, a sensitivity of filtering when the user is in a private location may be higher than a sensitivity of filtering when the user is in a public location, or a sensitivity of filtering at night may be higher than a sensitivity of filtering when the user during the daytime.

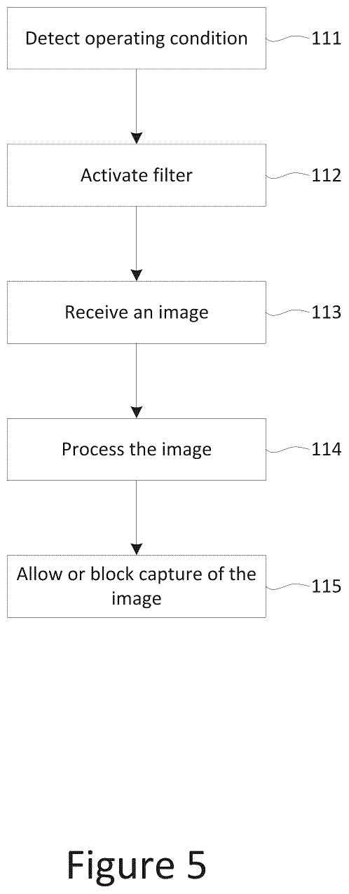

Referring to FIG. 5, there is shown another method of operating the filter 16 so as to allow or block the capture of an image. It will be appreciated that any features described with reference to FIG. 4 may be implemented with features described with reference to FIG. 5 and vice versa.

In a first step 111, the filter detects an operating condition and/or determines that an operating condition is met. For example, the operating condition may comprise an activation of the image sensor (e.g. as might occur when a user of the computer device selects a camera application).

In various embodiments, the operating condition may comprise one or more of: an activation of an image sensor being detected; an activation of an application being detected (e.g. a specific application identified by an administrator); a contextual condition being met, such as a time condition being met and/or a location condition being met; an image detection condition being met, e.g. the presence of a threshold number of users (or less than a threshold number of users) being detected in an image; and a proximity condition being met (e.g. to determine whether the computing device is within a certain proximity to a further computer device). The location condition may relate to the user being at a certain geolocation (e.g. as measured by a GPS sensor or a WiFi connection of the computer device) or the user being within a certain room, e.g. a bedroom or a locker room as may be determined by the geolocation or by image analysis. The proximity condition may be used so that when a child is near their parent, the filter 16 is disabled and/or so that the filter is only enabled when a child is alone.

The operating condition may comprise one or more of: an attempt to take a screenshot on a computer device, an attempt to initiate screen recording, and/or a use of a camera within a (e.g. third-party) application on the computer device.

It will be appreciated that the operating condition may comprise a plurality of conditions (e.g. a location condition and a time condition).

In some embodiments, the detection of the first type of content and/or the blocking of an image is based on a filtering parameter and/or is based on the operating condition (e.g. any of the operating conditions described above). For example, a strictness of the filtering may depend on a filtering parameter, where certain content may be allowed during the day but blocked at night.

In some embodiments, the detection and/or blocking is dependent on a context of a user or a user device. In some embodiments, the detection and/or blocking is dependent on a detected emotion of a user. For example, if a facial expression in an image suggests stress or coercion, then the filtering sensitivity may be raised so as to filter images more strictly than if an image suggests happiness.

In a second step 112, the filter activates based on the operating condition being met. For example, the filter may receive an activation command or may receive a power supply from the computer device. Typically, the activating of the filter comprises the filter providing a power supply to the cache 22. In this regard, the filter may comprise an (e.g. low power) component that is always on (e.g. that is on whenever the computer device is on) where this component may provide an activation signal to the other components of the filter when the operating condition is met, e.g. to provide power to the cache. By activating and deactivating the filter based on the operating condition, it is possible to regularly wipe the cache of the filter and also to avoid unnecessary power usage.

Typically, the default operating status of the filter is to not provide power to the cache 22. Typically, power is provided to the cache in dependence on the operating condition is met and then the provision of power is stopped following the completion of a filtering process (e.g. for a single image or for a plurality of images). The provision of power may be stopped when the operating condition is no longer being met. The filter may re-evaluate the operating condition following each image so that the filter continues processing images until, following a given image, the operating condition is no longer met (e.g. because a user has closed a camera application).

In a third step 113, the filter 16 receives the image from the image sensor 12 and in a fourth step 114, the filter processes the image to determine if content of the first type (e.g. inappropriate content) is present in the image.

In a fifth step 115, the filter 16 either allows or blocks capture (or storage) of the image based on the processing of the image. Equally, the filter may modify the image, e.g. to obscure inappropriate content in the image.

The method of FIGS. 4 and 5 has described a method of processing an image to detect content of a first type. This may comprise processing an image after a user has actively sought to capture or save that image (e.g. by clicking a ‘capture’ button on a camera interface. Equally, this may comprise processing an image even before a user has attempted to save that image. For example, as soon as a user opens a camera application and a camera is activated, the filter 16 may process images within a view or feed of the camera. Therefore, if a user opens a camera application while being naked, the filter may prevent these images from ever being shown to the user. Since the filter is implemented in hardware, this may be implemented by blocking a signal from the image sensor 12 so that this signal is not received by the image signal processor 14. Therefore, a user is not able to even view a feed from the camera, let alone to save any images. In this regard, the camera feed may be considered to provide a continuous capturing of images where a user is able to save these images to long-term memory by clicking a capture button. The filter may work on the initially unsaved images of the camera feed and may process these images before they are ever seen by a user or transmitted by the image signal processor (e.g. so that the images are not even visible to applications on the computer device until they have been processed).

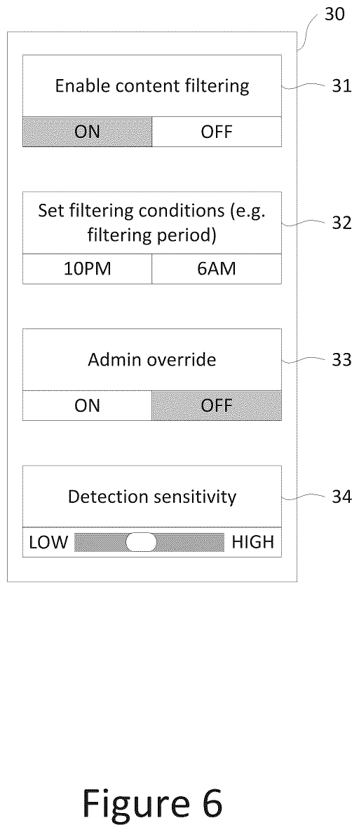

Referring to FIG. 6, there is shown a user interface 30 that enables an administrator to set operating parameters (e.g. the operating conditions) of the filter 16. These parameters may be fixed before the installation of the filter; equally, the administrator may be able to alter the parameters following the installation of the filter into the computer device.

Referring to FIG. 6, the operating parameters may comprise one or more of:
An enablement parameter 31. In particular, the administrator may be able to define whether the filter is active or inactive.
Filtering or operating conditions 32. For example, the administrator may be able to set a filtering period and/or a filtering location at which the filter becomes active.
An administrator override parameter 33. For example, an administrator that is using the computer device may be able to input an administrator code to override the filter and to enable the capturing of certain images. The administrator override parameter may enable capturing of an image that contains the first type of content. In some embodiments, the administrator override must be provided in order to change any other operating conditions or parameters or to view reporting logs associated with the filter 16 (e.g. the administrator override may comprise a password used to log into a control application).
A detection sensitivity parameter 34. For example, the administrator may be able to set a sensitivity of filtering (e.g. an acceptable level of nudity). The detection sensitivity parameter may comprise a slider as shown in FIG. 6; equally, the detection sensitivity parameter may comprise a plurality of filtering options. For example, the administrator may be able to select a list of content to filter (e.g. nudity, suggestive poses, offensive language or signs, underwear, etc.). This may, for example, enable a parent to alter the degree of filtering that is provided as a child ages.

In some embodiments, one or more of the operating conditions or parameters may be determined by a computer device or a processor, e.g. the filter processor 26. These conditions or parameters may be determined based on a characteristic of a user of the computer device. For example, the conditions or parameters may be determined based on an age or a knowledge of the user. This can be used to enable different ages of user to capture different types of images (where content that is inappropriate for children may not be inappropriate for young adults, and content that is inappropriate for young adults may not be inappropriate for older adults).

In some embodiments, an operating condition and/or a filtering parameter is dependent on an audio input. Therefore, the filter 16 may be arranged to block images and/or to alter a sensitivity of filtering based on an audio input, such as a phrase spoken by a user.

In some embodiments, an operating condition and/or a filtering parameter for a current image is dependent on an overlay or an item added to a previous image. For example, certain overlays may be found to be correlated with the taking of inappropriate images so that a determination that a user has selected such an overlay may be used to raise a filtering sensitivity (since the probability of an inappropriate image being taken is increased following the selection of this overlay).

In some embodiments, a plurality of administrators may be able to modify the operating parameters or the filtering parameters, where different administrators may have different levels or types of access. In practice, this may comprise providing different administrator rights to each of a parent and a teacher so that, for example, a parent can control the filter to prevent the capture of images containing nudity at night time and a teacher may control the filter to prevent the capture of images during lesson times.

### Alternatives and Modifications

It will be understood that the present invention has been described above purely by way of example, and modifications of detail can be made within the scope of the invention.

For example, while the detailed description has primarily considered the use of the filter 16 to filter images of nudity, it will be appreciated that the filter may more generally be used to filter any type of images based on a content of those images and/or data associated with those images. For example, the filter may be used to implement a geofilter if the first type of content comprises content associated with a given location (e.g. where the first type of content comprises buildings, the filter may filter images of urban environments).

While the detailed description has considered an example where the computer device is a smartphone, it will be appreciated that the filter 16 may be implemented with any type of computer device; for example, a personal computer (PC), a smart toy (e.g. a toy that is equipped with a camera); a wearable device; a tablet; a smart doorbell or other smart appliance, etc.)

While the detailed description has primarily considered the filtering of images, it will be appreciated that the filter 16 can also be used to process and filter videos at least because videos are composed of a plurality of image frames. The filter may process one or more of (or a combination of) these image frames. For example, the filter may be used to filter and process videos that are being streamed by a computer device. In some embodiments, the filter comprises a filter for filtering streaming (e.g. streaming of videos) by detecting content of the first type within the videos.

Where the filter 16 is used to process videos, the filter may be arranged to process each image frame of a video. Equally, the filter may be arranged to process a subset of the image frames, e.g. to process each 3rd frame or each 10th frame. In some embodiments, the filter is arranged to use a memory, e.g. the cache 22, as a buffer for the video. Therefore, the filter may store a duration of video (e.g. 10 frames of the video), process one or more of these frames, and then transmit this duration of video to the image signal processor 14 (e.g. based on the duration of video containing no inappropriate content). As with standalone images, these frames of a video are typically stored in a volatile memory to ensure that there is no long term storage of the frames by the filter.

The filter 16 may be arranged to process one of the frames of this duration of video in order to determine whether content of the first type is present in the video.

The frequency of processing and/or the duration of video may depend on an administrator input and/or on an operating parameter. For example, if a second type of content is detected in an image frame, then a frequency of processing may be increased. In a practical example, if the filter 16 detects that a user has removed their sweatshirt, then the filter may enable recording to proceed but may increase a frequency of processing. Then, if the filter detects that a user has removed their T-shirt, the filter may prevent any further recording. Similarly, the frequency of processing may be dependent on a location of the user or on the presence of other people in the video.

In some embodiments, the filter 16 is arranged to identify the first type of content based on a plurality of frames of a video. For example, the filter may be arranged to implement a machine learning model that is trained to receive a plurality of image frames and indicate the presence of the first type of content based on this plurality of frames. These frames may be consecutive frames of the video, but equally may be non-consecutive frames of the video.

In some embodiments, the filter 16 is arranged to process frames of a video using the same techniques, algorithms, and/or models that are used to process images. Equally, in some embodiments, the filter may comprise a dedicated video processing algorithm and/or model that is used to process frames of a video.

Similarly to the image processing arrangement, the filter 16 may be arranged to block image frames of a video from being transmitted to the image signal processor 14 and/or from being saved or shared by the computer device. In general, it will be appreciated that the video processing arrangement is a subset of the image processing arrangement (and that a filter that is arranged to process and image is equally arranged to process a frame of a video and thus to process a video) and that the features described in relation to the filtering of images can be applied to the filtering of videos (and vice versa).

Typically, the filter 16 is arranged to transmit frames of the video to the image signal processor 14 following processing of these frames, e.g. so that a user is able to view these frames while also recording new frames of the video. Where content of the first type is detected in a particular frame of a video, the filter may act to modify or block this particular frame as well as future frames of the video. For example, the filter may be arranged to stop a recording process by blocking an image signal (or a video signal) from reaching the image signal processor. This may comprise the filter transmitting a hardware interrupt or signal to a camera API or to a firmware layer of the filter.

As with images, any blocking or modification of a video may lead to a log being kept of a video capture event and/or may lead to a report being sent to an administrator.

Where content of the first type is detected in a frame of a video, the filter 16 may also be arranged to block, modify, or delete frames previous frames of the video (including frames that have been transmitted to the image signal processor 14 prior to this detection of content of the first type). This may comprise the filter transmitting a modification signal to the image signal processor to enact these changes. For example, where a user starts recording a video fully clothed and then proceeds to remove their clothing, the filter may end the recording as soon as nudity is detected. The filter may also signal the image signal processor to delete the initial portion of the video that was recorded before the detection of the nudity and/or may prevent the saving or transmission of this initial portion.

In some embodiments, the filter 16 may be arranged to prevent transmission of an image signal to the image signal processor until a recording process is completed. Therefore, the filter is able to process the whole of the video to identify any inappropriate content before the video is forwarded to the image signal processor. This may involve the filter saving video frames in volatile memory only until the completion of the video. A drawback to this mode of operation is that it may prevent a user from viewing their video as it is recorded. Therefore, as described above, the filter may be arranged to transmit a signal (e.g. an image signal) to the image signal processor 14 so as to forward frames that have been processed and deemed to be appropriate. This may lead to a small lag between the recording of video and the display of this video to a user, but this lag may be so small as to be imperceptible to the user. In this regard, where the filter 16 is used to filter video, the filter is typically arranged to filter video in real-time or near real-time (e.g. to filter the video while it is being recorded).

The filter 16 may also be arranged to prevent transmission or saving of the video before completion of recording. Therefore, a viewer may be able to view a video while it is being recorded, but not to save or send any of the video until recording has completed.

Processing a video may comprise identifying that a user has initiated a video capture process and processing this captured video. Equally, processing a ‘video’ may comprise processing a plurality of images that are captured by the image sensor 12 or that are present in a video feed. For example, once a user opens a camera application, the filter 16 may identify a plurality of (e.g. consecutive) images captured by the image sensor and then process this plurality of images to detect content of the first type. This may occur before a user is able to access the camera application or to even attempt to actively record a video.

Reference numerals appearing in the claims are by way of illustration only and shall have no limiting effect on the scope of the claims.

1. An apparatus for filtering images, the apparatus comprising:
a processor; and
a memory component having instructions stored thereon that, when executed by the processor, cause the processor to perform operations comprising:
receiving an image signal from an image sensor of a computer device, the image signal comprising an image captured by the image sensor;
processing the image signal to determine whether content of a first type is present within the image; and
based on content of the first type not being present within the image, transmitting the image signal to an image signal processor of the computer device; or
based on content of the first type being present within the image: blocking the image signal from being sent to the image signal processor or modifying the image signal before transmitting the image signal to the image signal processor.

2. The apparatus of claim 1, wherein the memory component comprises a volatile memory component for providing temporary storage; and wherein the filter is arranged to store the image using the volatile memory component.

3. The apparatus of claim 2:
wherein the filter is arranged to stop the provision of power to the volatile memory component following the processing of the image signal; and/or
wherein the filter is arranged not to provide power to the volatile memory in a default state.

4. The apparatus of claim 2, wherein the filter is arranged to stop the provision of power to the volatile memory component when a deactivation condition is satisfied, preferably wherein the deactivation condition comprises one or more of: a user closing a camera application; a user stopping use of the image sensor; and a user locking the computer device.

5. The apparatus of claim 1, wherein the operations comprise clearing a memory and/or a cache of the apparatus following the determination of whether content of the first type is present so as to delete the image from the apparatus.

6. The apparatus of claim 1, wherein, based on content of the first type being present in the image, the operations comprise one or more of: disabling a shutter trigger, altering a frame buffer of the image sensor and/or the computer device, preventing storage of the image; preventing transmission of the image and/or replacing pixels of the image in real time.

7. The apparatus of claim 1, wherein the memory component comprises an enclave for storing data permanently; wherein the enclave stores parameters and/or weights of a machine learning model; wherein determining whether content of the first type is present comprises determining whether content of the first type is present using the machine learning model.

8. The apparatus of claim 1, wherein the first type of content comprises one or more of: nudity, suggestive poses, and contextual indicators of private settings.

9. The apparatus of any claim 1, wherein the operations comprise modifying and/or deleting previously taken images based on content of the first type being present.

10. The apparatus of claim 1, wherein:
the apparatus is arranged to prevent the capture of images using the image sensor based on a fault in the apparatus being detected; and/or
the apparatus is arranged to block the transmission of the image signal to the image signal processor when the apparatus is in a default state and/or an off state.

11. The apparatus of claim 1, being an apparatus for filtering video, wherein the operations comprise:
receiving one or more image signals from an image sensor of a computer device, the image signals comprising a plurality of images captured by the image sensor, the plurality of images being associated with a video;
processing the image signals to determine whether content of a first type is present within the plurality of images; and
based on content of the first type not being present within the plurality of images, transmitting the image signals to an image signal processor of the computer device; or
based on content of the first type being present within the plurality of images: blocking one or more of the image signals from being sent to the image signal processor or modifying one or more of the image signals before transmitting the image signal to the image signal processor.

12. The apparatus of claim 1, wherein the operations comprise:
identifying an operating condition of the apparatus;
determining that the operating condition is satisfied; and
processing the image based on the operating condition being satisfied.

13. The apparatus of claim 12, wherein determining that the operating condition is satisfied comprises one or more of:
detecting an activation of the image sensor;
detecting an activation of an application;
determining that a contextual condition is satisfied, preferably determining that a time or location condition is satisfied;
determining that an image detection is satisfied;
determining that a proximity condition is satisfied, preferably determining that the computer device is within a threshold distance of a further computer device;
determining that an audio input condition is satisfied; and
detecting a gesture in the image.

14. The apparatus of claim 1, comprising processing the image in dependence on a filtering parameter; wherein the filtering parameter is dependent on one or more of:
an administrator setting, preferably a detection sensitivity parameter set by an administrator;
a time and/or location at the time of the image being captured;
an expression detected in the image;
a gesture detected in the image;
a characteristic of a user of the computer device, preferably an age of the user; and
an audio input detected by a microphone of the apparatus and/or the user device.

15. The apparatus claim 1, wherein the operations comprise: performing a first stage of filtering and a second stage of filtering, wherein the second stage of filtering is more detailed than and/or requires more time than the first stage of filtering; wherein the apparatus is arranged to perform the first stage of filtering on an image signal before forwarding said image signal to the image signal processor and to perform the second stage of filtering on the same image signal after forwarding said image signal to the image signal processor.

16. The apparatus of claim 15, wherein the apparatus is arranged to alter a filtering parameter for implementing the first stage of filtering on a first image in dependence on the processing of a second image during the second stage of filtering.

17. A computer device comprising:
the apparatus of claim 1;
the image sensor; and
the image signal processor.

18. The device of claim 17, wherein all signals transmitted from the image sensor to the image signal processor are arranged to be transmitted via the apparatus.

19. The device of claim 17, wherein:
the image sensor is arranged to transmit image signals to the image signal processor via the apparatus based on an operating condition of the apparatus being satisfied; and/or
the image sensor is arranged to transmit image signals directly to the image signal processor based on an operating condition of the apparatus not being satisfied.

20. A method performed by an apparatus for filtering images, the method comprising
receiving an image signal from an image sensor of a computer device, the image signal comprising an image captured by the image sensor;
processing the image signal to determine whether content of a first type is present within the image; and
based on content of the first type not being present within the image, transmitting the image signal to an image signal processor of the computer device; or
based on content of the first type being present within the image: blocking the image signal from being sent to the image signal processor or modifying the image signal before transmitting the image signal to the image signal processor.
